(19) United States
(12) Patent Application Publication
(10) Pub. No.: US 2006/0260494 A1
(43) Pub. Date: Nov. 23, 2006

(54) Method of transfer printing

(76) Inventor: Ming-Feng Tan, Fongyuan City (TW)

Correspondence Address: Ming-Feng Tan, P.O. Box No. 6-57, Junghe, Taipei, 235, TW

(21) Appl. No.: 11/134,432

(22) Filed: May 23, 2005

(51) Int. Cl. B41F 3/34

(52) U.S. Cl. 101/492

(57) ABSTRACT

A method of transfer printing includes first pasting an adhesive of a solvent-type on an object, then covering a transfer film on the object under a condition of half-dry of the adhesive, and next exerting pressure according to a form of the object for uniformly gluing an ink of the transfer film onto the object, and finally tearing off a plastic film on a surface of the transfer film, thereby accomplishing the transfer printing. In addition, a mold release agent is pasted between the plastic film and the ink, and the viscosity of the adhesive is larger than that of the mold release agent, so as to uniformly and firmly attach the ink to the object, and to remove the mold release agent along with the plastic film, during the aforementioned workflow.

### BACKGROUND OF THE INVENTION

(a) Field of the Invention

The present invention relates to a method of transfer printing, and more particularly to a method wherein an adhesive of a solvent-type and a mold release agent between a plastic film and ink is used to accomplishing the transfer printing.

(b) Description of the Prior Art

There are many drawbacks of an existing thermal transfer printing technique:

1. The processing cost is high. A lot of thermal energy needs to be consumed for the thermal transfer printing, wherein a large quantity of expensive thermally molten glues is used. The working procedure of processing is long, such that a large space should be occupied for entire machinery equipment.

2. It is difficult to guarantee the quality of processing. A physical effect of expanding in hot and shrinking in cold will be generated to a processed object due to the necessity of heating up, which results in the difficulty in controlling the stability of dimension of the processed object after performing the transfer printing. If a product needs to go through 2nd or more processing procedures, all kinds of drawbacks such as a higher total defect rate, an inferior stability of dimension of printing, and instability of relative position of cutting will occur. As the processed object has a phenomenon of expanding in hot and shrinking in cold, a large space is needed to store the processed object, so as to completely cool down the processed object for decreasing an ill condition resulting from thermal deformation. However, temperature in an ambient environment has a large effect on the cooling efficiency of the processed object; therefore, the size of storing space and whether the processed object can be completely cooled down remain unknown. It is difficult to control the necessary size of the storing space, and the time needed for completely cooling down the processed object. Similarly, as a transfer printing object also has a phenomenon of expanding in hot and shrinking in cold after being heated up, the ink that has already been printed transferring will be shrunk in dimension after completely cooling down the processed object. If elongation and a breaking strength of the ink itself are not as high as those of the processed object, the phenomenon of shrinking in cold of the processed object, after being cooled down, will generate a local cracking to the ink that has been printed transferring. Therefore, to avoid the occurrence of this kind of phenomenon, inks of higher elongation and breaking strength should be chosen, such as a PU series, an EVA series, a soft PVC series, etc. The cost of these kinds of transfer films is higher than that of a transfer film using an ordinary ink, and these transfer films should be made by a special transfer film printing machine. It is due to that the breaking strength and viscosity of this kind of ink are higher; therefore the speed of the printing machine should be faster during printing, in order to clearly print the ink on the transfer films. However, an oven of an ordinary printing station will not be long enough for this faster speed and hence cannot completely dry the ink. Therefore, this kind of transfer film needs to be printed on a special printing machine with a lengthened oven. Nevertheless, the printing machine with the lengthened oven is a special machine with few quantities on the market, and vendors who can supply are too few, thereby causing a higher price to this kind of transfer film. On the other hand, when products of thermal transfer printing are used in higher temperature, the viscosity of adhesive will be reduced with an increase of temperature (usually as high as 90 degree Celsius), or even the adhesive can be totally damaged, as a thermally molten glue is used as the adhesive.

3. It is not suitable for processing a closed-cell linking foam work-piece. An internal organization of the close cell linking foam is composed of many small cells in close proximity. As the bubbling material is heated up, the balloons inside the organization will be swelling, thereby enlarging the dimension of original work-piece. However, the dimension of transfer film to be printed transferring is fixed; It's so difficult to match together with them. If a thermal transfer printing process is performed to a processed object with the original dimension, the dimension of pattern on the transfer film will be shrunk when the processed object is completely cooled down after accomplishing the thermal transfer printing, and the higher the temperature of heating, the more severe the shrinking of the dimension of the pattern. If a continuous transfer printing is needed for a product, the dimension of length of the processed object should be increased during being heated up, and the extra length will not fit with the dimension of transfer film without change of dimension. Hence, one of every two or three patterns cannot be used completely. On the other hand, if the processed object is a roll with infinite length, the phenomenon of expanding in hot and shrinking in cold of the processed object will be double. Moreover, the factor of expanding in hot and shrinking in cold will become irregular, for example, the breaking strengths at front, middle, and back will be different. After performing the transfer printing to a whole roll, the dimension of each pattern will be different, resulting in extreme difficulty in the processing of next working procedure.

### SUMMARY OF THE INVENTION

The primary objective of the present invention is to provide a method of transfer printing, and more particularly to a method wherein an adhesive of a solvent-type is first pasted on a surface of an object, then a transfer film is covered on the surface of object when the adhesive volatilizes to a half-dry condition, next a pressure is exerted according to a type of object in order to uniformly glue an ink of the transfer film on the object, and finally a plastic film on a surface of the transfer film is removed, thereby accomplishing the transfer printing.

In addition, a mold release agent is pasted between the plastic film and the ink, and a viscosity of the adhesive is larger than that of the mold release agent, so as to uniformly and firmly attach the ink to the object during the aforementioned procedure, while the mold release agent is removed along with the plastic film.

In the aforementioned procedure of transfer printing, as the transfer printing is performed under a condition of normal temperature, and a strength of pressure exerted is controlled according to a form and type of the object, therefore deformation will not be generated to the transfer film and the object during the process of transfer printing, so as to keep the size of ink after performing transfer printing to be the same as that of original ink of the transfer film.

Furthermore, in the method of transfer printing, as the pressure exerted can be controlled according to the form and type of object, the object will not be broken by the pressure during the process of exerting pressure.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of the present invention.

FIG. 2 shows a first schematic view of an implementation of the present invention.

FIG. 3 shows a second schematic view of an implementation of the present invention.

FIG. 4 shows a third schematic view of an implementation of the present invention.

FIG. 5 shows a fourth schematic view of an implementation of the present invention.

FIG. 6 shows a fifth schematic view of an implementation of the present invention.

FIG. 7 shows a block diagram of a further implementation of the present invention.

FIG. 8 shows a schematic view of a further implementation of the present invention.

### DETAILED DESCRIPTION OF THE PREFERRED EMBODIMENTS

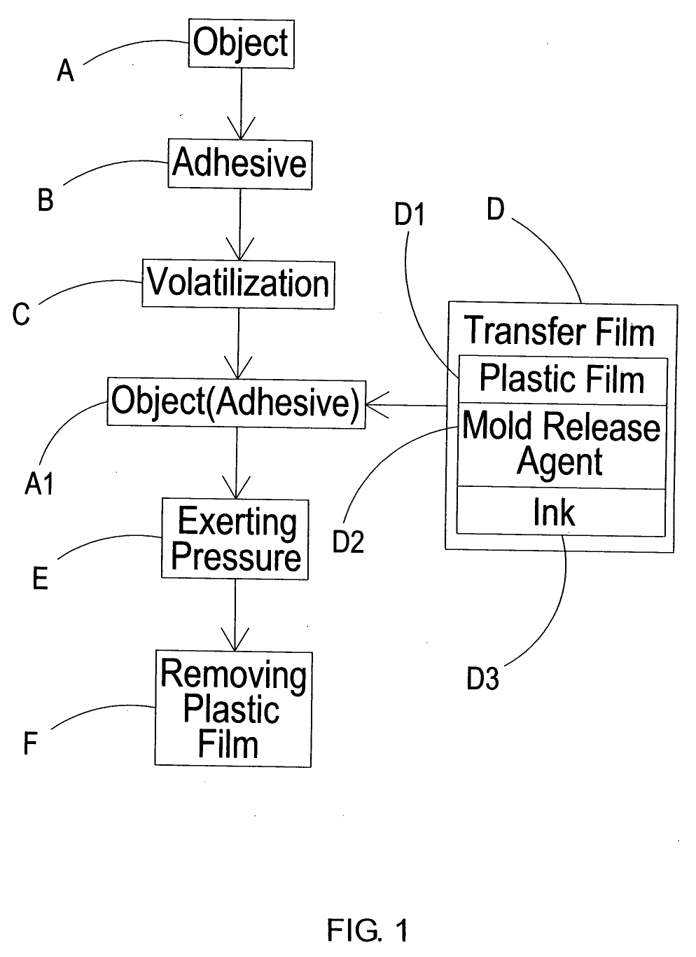

As shown in FIG. 1, which is a workflow consisting of an object A, an object (adhesive) A1, an adhesive B, volatilization C, a transfer film D, exerting pressure E, and removing a plastic film F. The transfer film D is provided with a plastic film D1, a mold release agent D2, and an ink D3, wherein the ink D3 is glued on the plastic film D1 through the mold release agent D2.

A feature of the workflow lies in that under a condition of normal temperature of about 10 to 45 degree Celsius, the adhesive of a solvent-type B is uniformly pasted on the object to be printed transferring A, and to uniformly cover the transfer film D on the object (adhesive) A1 after the adhesive B volatilizes to 40 to 60% (about a level of not sticking a hand upon touching the adhesive B).

A pressure E is exerted on the object (adhesive) A1 covered with the transfer film D. Depending on the form and type of the object A, the pressure exerted E is about 5 to 100 kilograms.

After accomplishing the aforementioned steps, the plastic film F on the transfer film D is removed, so as to glue the ink D3 which is on the transfer film D onto a surface of the object A through the aforementioned steps.

As a viscosity of the adhesive B is larger than that of the mold release agent D2, the ink D3 can be uniformly and firmly attached to the object (adhesive) A1, and the plastic film D1 can be removed along with the mold release agent D2 upon removing the plastic film D1, during the aforementioned procedure.

The step of exerting pressure E can be further configured to be exerting pressure manually, exerting pressure with a roller, exerting pressure with a platen, and a pressure-exerting technique related to transfer printing process.

The adhesive B can be further a multipurpose glue and a glue material for sticking related objects.

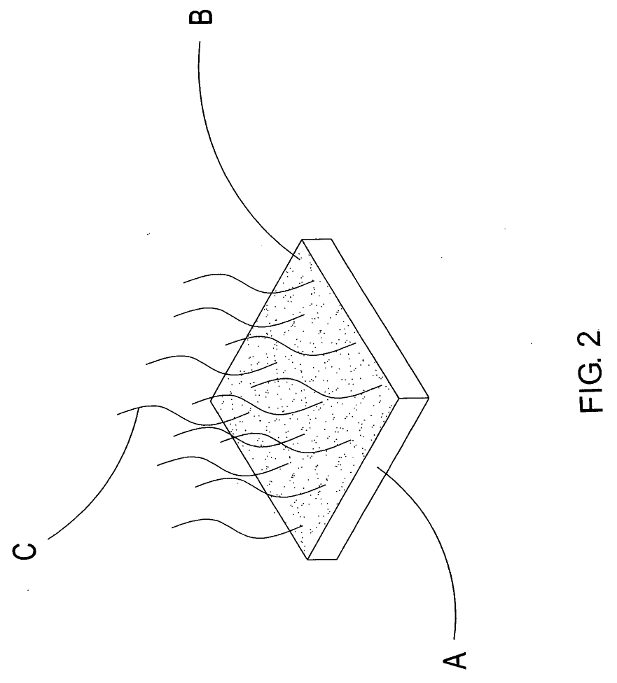

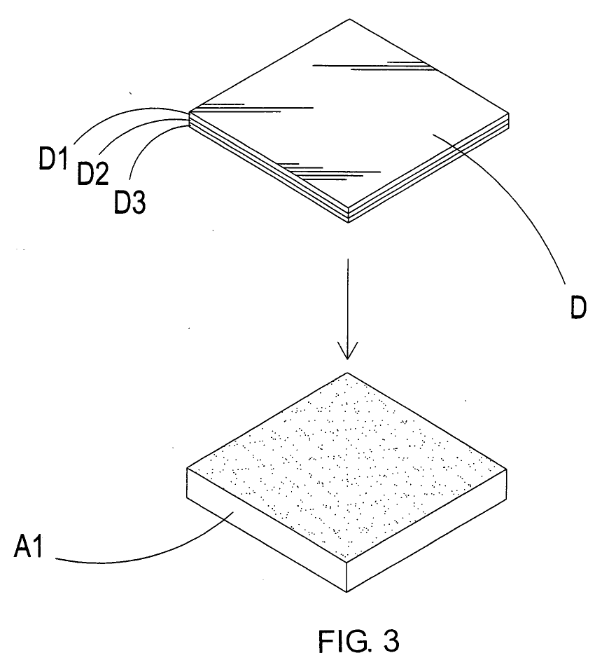

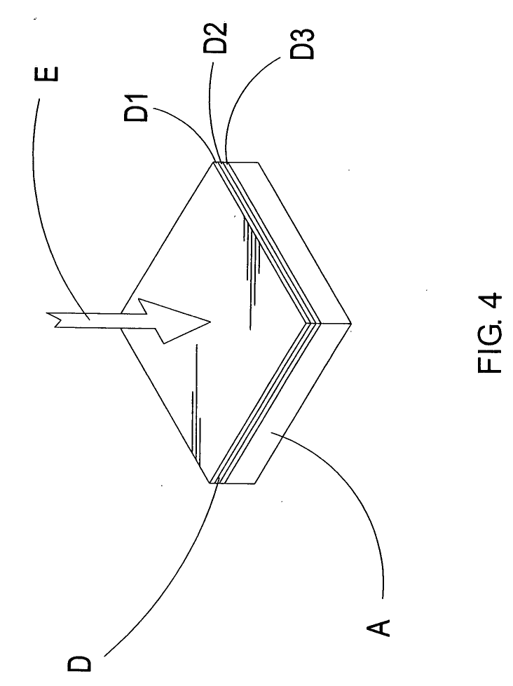

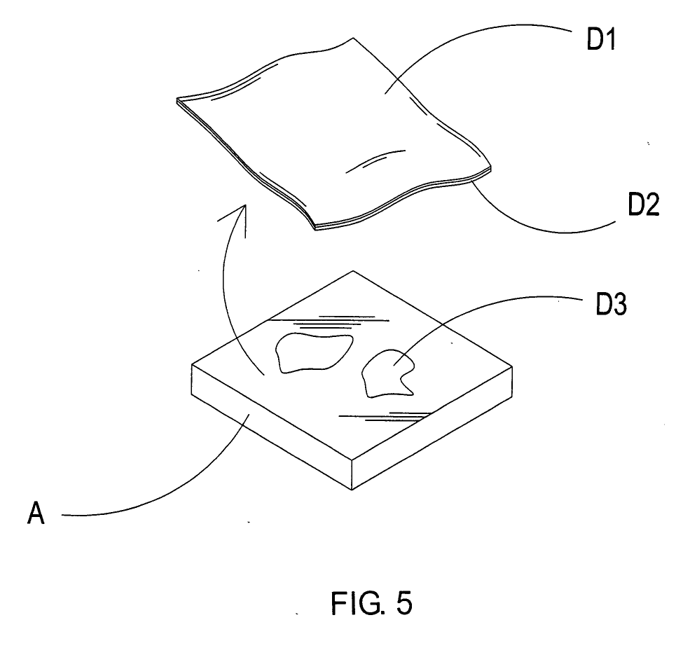

Referring to FIG. 2, it shows an implementation method of the present invention. An adhesive of a solvent-type B is uniformly pasted on a surface of an object A, and laid aside after being pasted until volatilizes to 40% to 60% of initial viscosity (about a level of not sticking a hand upon touching the adhesive B). Next, a transfer film D is uniformly attached on an object (adhesive) A1 (as shown in FIG. 3), such that an ink D3 which is on the transfer film D can be uniformly glued on the object A upon exerting pressure E (as shown in FIG. 4). In addition, upon exerting the pressure E, the strength of pressure exerted is controlled according to a form and type of the object, and is about 5 to 100 kilograms. Following the aforementioned steps (as shown in FIG. 5), a plastic film D1 is removed from the object A to accomplish the procedure of transfer printing.

Furthermore, a mold release agent D2 is pasted between the plastic film D1 and the ink D3, so as to quickly remove the plastic film D1, and to avoid the falling off of the ink D3 which is printed transferring on the object A, upon removing the plastic film D1.

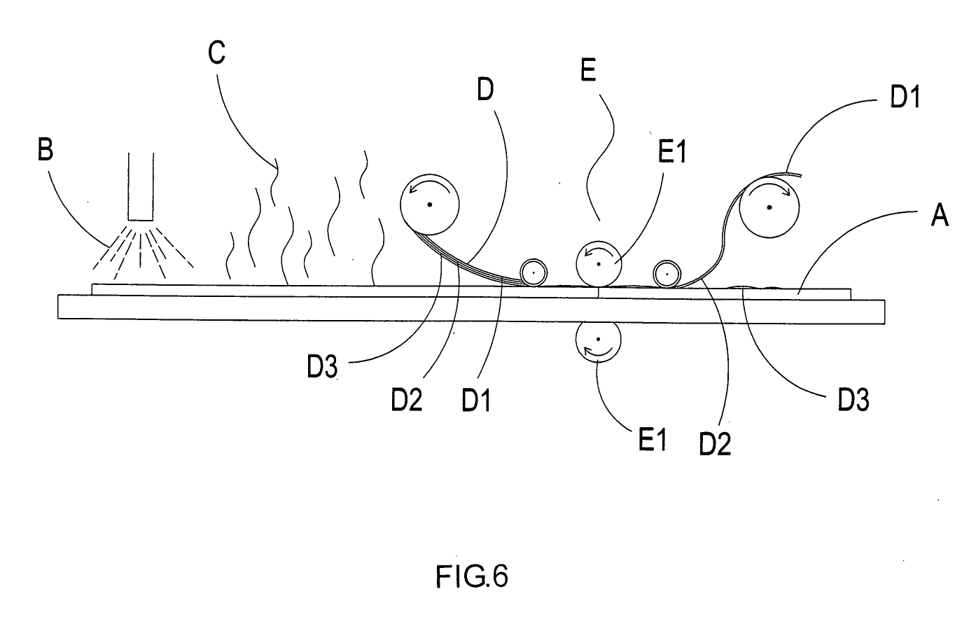

Referring to FIG. 6, in an ordinary production line, an adhesive of a solvent-type B is first uniformly pasted on an object A, and a transfer film D is uniformly covered on the object A after laying aside the adhesive B for volatilizing to 40% to 60% of initial viscosity. Whereas in exerting pressure E, a common method of exerting pressure with a roller E1 is applied to uniformly exert pressure. An ink D3 which is on the transfer film D can be uniformly attached on the aforementioned object A by uniformly exerting this pressure E. Finally, a plastic film D1 is removed from the object A to accomplish the transfer printing. Moreover, a mold release agent D2 is pasted between the plastic film D1 and the ink D3, so as to enable quickly removing the plastic film D1, and to avoid the falling off of the ink D3 which is printed transferring on the object A, upon removing the plastic film D1.

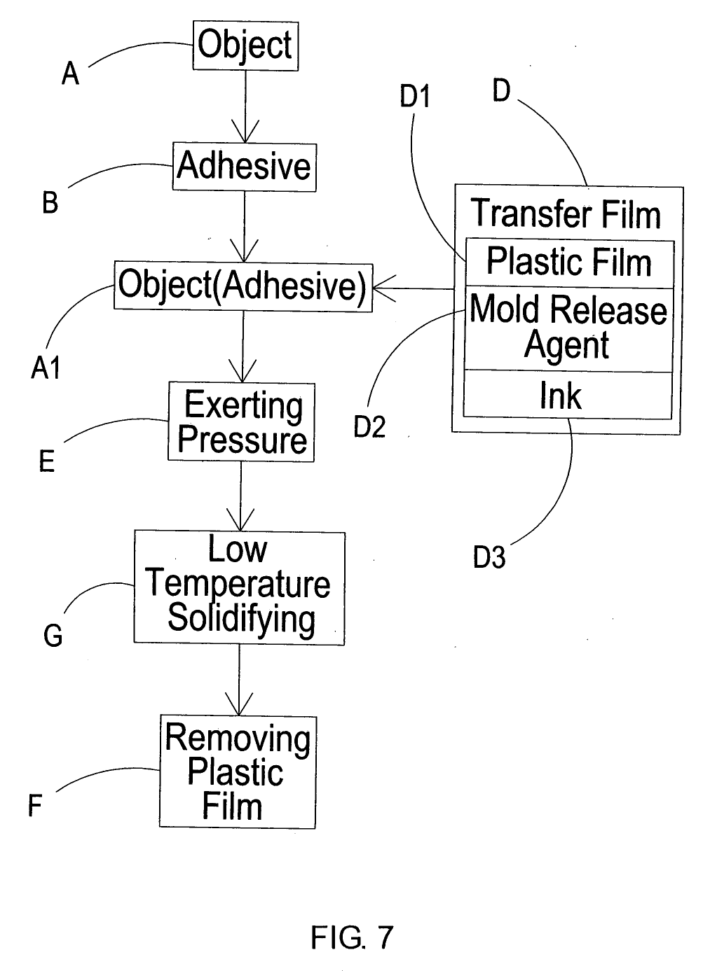

Referring to FIG. 7, the present invention further uses a method of low temperature transfer printing, which is a workflow composed of an object A, an adhesive B1, a transfer film D, exerting pressure E, low temperature solidifying G, and removing a plastic film F. A feature of the workflow lies in that an adhesive of a solvent-type is first made into an adhesive of a type of low temperature solidifying B1 under a condition of low temperature of negative 20 to 10 degree Celsius, next the adhesive B1 is uniformly pasted on the object A, and then the transfer film D is uniformly covered on an object (adhesive) A1 with pressure E exerted on the object (adhesive) A1 covered by the transfer film D, wherein the pressure exerted E is about 5 to 100 kilograms according to a form and type of the object A. A low temperature solidifying G is performed to the aforementioned object (adhesive) A1 along with the attached transfer film D after exerting the pressure E. After solidifying the adhesive B1 from a liquid state to a solid state, a plastic film F on the plastic film D is removed through the step of removing the plastic film F, so as to glue an ink D3 which is on the transfer film D onto a surface of the object A through the aforementioned steps. As a viscosity of the adhesive B is higher than that of the mold release agent D2, the ink D3 can be uniformly and firmly attached on the object (adhesive) A1 during the aforementioned process, and the plastic film D1 can be removed along with the mold release agent D2 upon removing the plastic film D1.

The step of exerting pressure E can be further configured to exerting pressure manually, exerting pressure with a roller, exerting pressure with a platen, and technique of exerting pressure used in a related transfer printing process.

The adhesive B can be further a multipurpose glue and a glue material that can stick related objects.

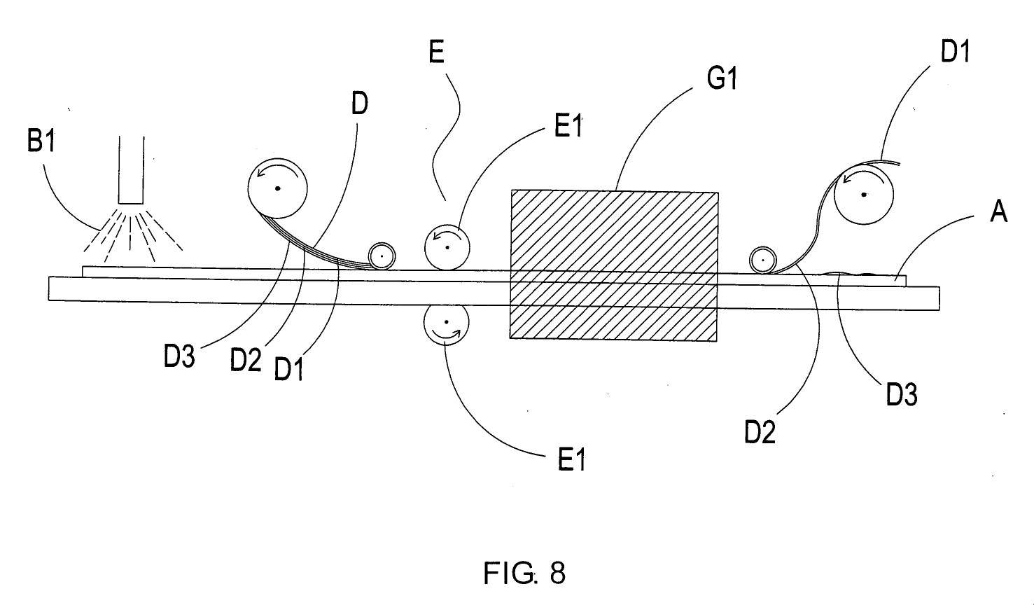

As shown in FIG. 8, in an ordinary production line, an adhesive B1 of a type of low temperature solidifying is uniformly pasted on an object A, and a pressure E is exerted on an object (adhesive) A1 covered with a transfer film D, after uniformly covering the transfer film D on the object (adhesive) A1. The pressure exerted is about 5 to 100 kilograms according to a form and type of the object A, upon exerting the pressure E.

The aforementioned object (adhesive) A1 along with the attached transfer film D after exerting the pressure are fed into a low temperature device G1 to perform a low temperature solidifying G to the adhesive B1. After solidifying the adhesive B1 from a liquid state to a solid state, a plastic film F on the transfer film D is removed, so as to glue an ink D3 which is on the transfer film D onto a surface of the object A.

The advantages of the present invention are listed below:
1. It can solve a problem of deformation and error in dimension caused by expanding in hot of a product upon passing through a thermal transfer printing machine, so as to attach patterns of the product more firmly.
2. It uses an adhesive of a solvent-type which has a better viscosity, so as to enable patterns of products to be more clear, more beautiful, more tolerable, having a better effect of attachment, and a better water-proof function, and to increase a level of temperature tolerability of the products.
3. The method of technique of the present invention is simple, and the process of operation is easy, so as to lessen a conventional technique requiring a drying in a constant temperature and adding a high heat to a roller press for a thermal transfer printing, thereby saving energy and lowering production cost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of transfer printing comprising a workflow containing an object, an adhesive, volatilization, an object (adhesive), a transfer film, exerting pressure, and removing a plastic film, wherein the transfer film is provided with the plastic film, an ink, and a mold release agent with viscosity smaller than that of the adhesive; a feature of the workflow being uniformly pasting the adhesive of a solvent-type on the object to be printed transferring in a condition of normal temperature of about 10 to 45 degree Celsius, and uniformly covering the transfer film on the object (adhesive); exerting pressure on the aforementioned object (adhesive) with a pressure of about 5 to 100 kilograms; removing the aforementioned plastic film on the transfer film by the step of removing a plastic film; a viscosity of the adhesive larger than that of the mold release agent, enabling the ink to be uniformly and firmly attached to the object, and removing the plastic film along with the mold release agent during the aforementioned workflow.

2. The method of transfer printing according to claim 1, using further a method of low temperature transfer printing comprising a workflow which is composed of an object, an adhesive, a transfer film, exerting pressure, low temperature solidifying, and removing a plastic film; a feature of the workflow being making the adhesive of a solvent-type into an adhesive of a type of low temperature solidifying under a condition of low temperature of negative 20 to 10 degree Celsius, and uniformly pasting the aforementioned adhesive on the object; exerting pressure on the object (adhesive) with pressure of about 5 to 100 kilograms, after uniformly covering the transfer film on the aforementioned object (adhesive); a low temperature solidifying performed to the aforementioned object (adhesive) along with the attached transfer film after exerting the pressure, and removing the plastic film from the transfer film through the step of removing the plastic film after solidifying the adhesive from a liquid state to a solid state, so as to glue the ink which is on the transfer film onto an object of the object through the aforementioned steps.

3. The method of transfer printing according to claim 1, wherein the step of exerting pressure can be further configured to be exerting pressure manually, exerting pressure with a roller, exerting pressure with a platen, and pressure-exerting technique used in a related process of transfer printing, and with a pressure of 5 to 100 kilograms.

4. The method of transfer printing according to claim 2, wherein the step of exerting pressure can be further configured to be exerting pressure manually, exerting pressure with a roller, exerting pressure with a platen, and pressure-exerting technique used in a related process of transfer printing, and with a pressure of 5 to 100 kilograms.

5. The method of transfer printing according to claim 1, wherein the adhesive can be further a multipurpose glue and a glue material that can stick related objects.

6. The method of transfer printing according to claim 2, wherein the adhesive can be further a multipurpose glue and a glue material that can stick related objects.
